(19) United States
(12) Patent Application Publication
(10) Pub. No.: US 2007/0024238 A1
(43) Pub. Date: Feb. 1, 2007

(54) Mobile charging

(75) Inventors: Shogo Nakade, Tokyo (JP); Takaharu Fujii, Kanagawa (JP); Kenichi Hashizume, Kitagunmagun Gunma (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/189,800

(22) Filed: Jul. 27, 2005

(51) Int. Cl. H02J 7/00

(52) U.S. Cl. 320/108

(57) ABSTRACT

A kit comprising an inductive charger having a first coil and a portable device having an energy store and a second coil coupled to the energy store whereby the energy store can be charged from a varying electrical field applied across the first coil, the charger and the device being configured remotely from the coils for encouraging coupling between the first and second coils when the charger and the device are located against each other.

This invention relates to arrangements for permitting devices to be charged with electrical energy when their users are out and about.

Many portable devices are powered by rechargeable electrical energy sources such as batteries and fuel cells. Examples include mobile phones, cameras, PDAs (personal digital assistants) and torches. An individual may carry many such devices with him. The energy sources might run out of energy whilst the user is out and about. If the user wants to be able to continue to use a device after its battery has run out in that situation then he can take a spare battery for the device with him. However, each device might use a different type of battery or fuel cell: having a different physical size and/or different electrical characteristics. It is highly inconvenient for the user to carry a battery for each device.

Mobile charging units for charging batteries by means of an electrical connection to the battery are known. Such charging units allow a user to charge the battery by connecting the unit to the portable device that contains the battery and then operating a handle or other means to cause electrical current to flow through an electrical connection between the charging unit and the battery. However, different portable devices have different physical interfaces by which their batteries are connected to a charger. Therefore, a different such charging unit may be needed for each portable device.

There is therefore a need for an improved means of allowing a user to recharge the energy source of a portable device when he is out and about.

Inductive charging systems are known. Such systems are described in, for example, U.S. Pat. No. 5,600,225 and U.S. Pat. No. 6,184,651. The reader is referred to those documents for a description of the principles of inductive charging. In inductive charging, a portable device is equipped with a coil that can be energised inductively by a coil in a nearby charging unit. Energy can thus be conveyed from the charging unit to the portable device, and can be used to charge a battery of the portable device. Inductive charging systems suffer from a number of problems. First, inductive charging units that have so far been described are fixed and/or mains-electricity-powered systems and so cannot be used when a user is out and about. Second, for inductive charging to be efficient it requires precise setting of the relative positions of the coils: otherwise charging efficiency drops significantly. One solution to this is to use a cradle built into the charging device for holding the charged device relative to the charging device. However, the same relative position is not necessarily right for different types of device since their coils might be in different positions, and in any case they might not fit into the cradle. Third, if means are provided for encouraging the coils to interact favourably, for example by lying next to each other, those means are typically located so that they lie substantially within the region of magnetic coupling between the coils. That can reduce the degree of coupling, making the system less efficient.

According to the present invention there is provided a kit comprising an inductive charger having a first coil and a portable device having an energy store and a second coil coupled to the energy store whereby the energy store can be charged from a varying electrical field applied across the first coil, the charger and the device being configured remotely from the coils for encouraging coupling between the first and second coils when the charger and the device are located against each other.

The present invention will now be described by way of example with reference to the drawings.

In the drawings:

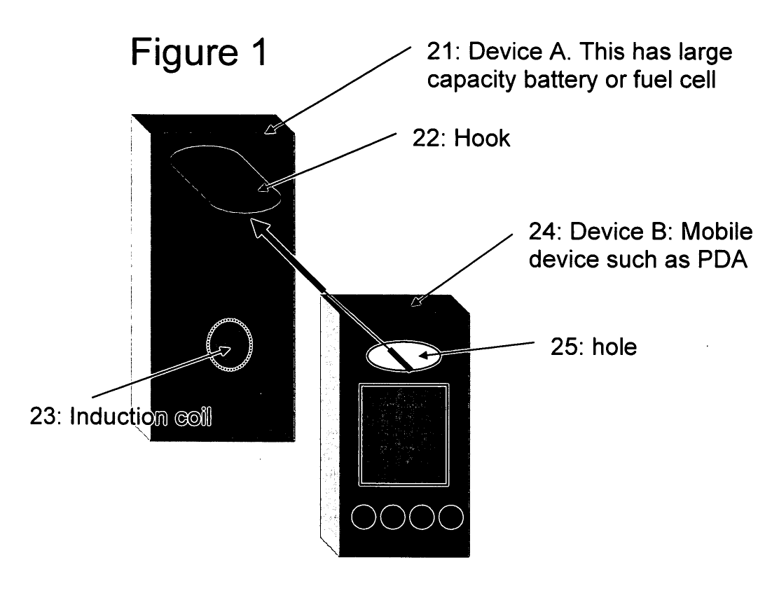

FIG. 1 illustrates a portable device and a portable charging unit; and

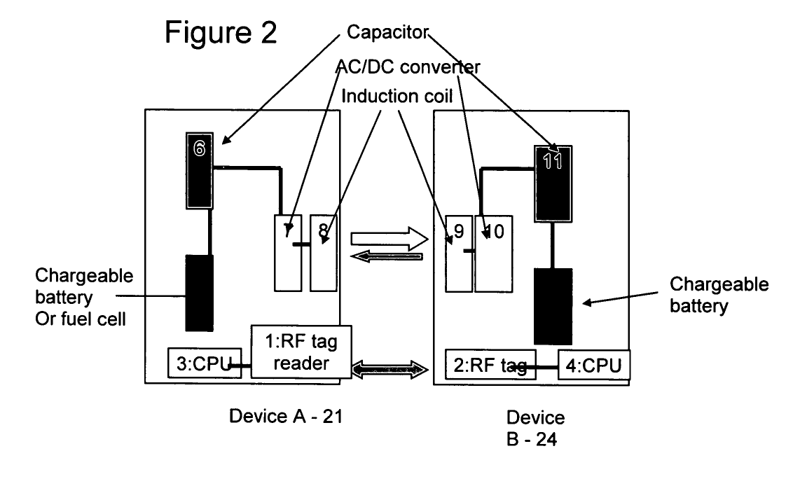

FIG. 2 is a schematic diagram of the portable device and a portable charging unit of FIG. 1.

FIG. 1 shows a portable device 24 and a portable charging unit 21. The portable device 24 can provide functions to a user by drawing on the power of an electrical power source such as a battery or capacitor of the device. The portable device has an inductive pickup such as a coil and has the capability of inductively charging its battery using energy received from that pickup. The portable charging unit 21 has a self-contained energy store such as a battery (preferably a relatively large capacity battery) or a fuel cell. The portable charging unit also has an inductive source such as coil 23, and has the capability of energising that source using energy from its energy store. The portable charging unit can therefore be used to inductively charge portable devices. Since it does so without the need for an electrical connector of a certain physical type, it is not limited by the type of electrical connector that the portable device has. Provided there is effective coupling between the inductive pickup and the inductive source the portable charging unit can charge any device that can receive inductive charging.

The devices of FIGS. 1 and 2 will now be described in more detail.

As illustrated in FIG. 2, the charging unit 21 comprises a self-contained local energy source 5. This could for example be a battery or a fuel cell. The local energy source is preferably but not necessarily rechargeable. The energy source 5 is connected via a capacitor 6 to a DC to AC converter 7. This utilises energy from the energy source 5 to form an oscillating electrical field in coil 8, which generates a magnetic field for inductive charging. Coil 8 acts thus as a primary coil and an inductive source for charging the charged device 24. The unit 24 to be charged comprises a secondary coil 9 which acts as an inductive pick-up for receiving the magnetic field from the coil 8. This induces an electrical field in the coil 9 which is fed through an AC to DC converter 10 and a capacitor 11 to an electrically rechargeable energy source 12, such as a rechargeable battery. Together these components of the devices 21 and 24 can cooperate to enable the energy source 12 to be inductively charged. The battery 12 is the power source for the device 24 in normal operation, and the device 24 can therefore be revitalised by charging from device 21.

US 2003/0003971, to which the reader is referred and which is incorporated herein by reference, describes further principles and options for inductive charging.

In preferred embodiments of the devices 21 and 24 various features may be provided to assist efficient charging.

First, the devices may be provided with features that are intended to physically interlock or otherwise cooperate so as to assist a user to mutually align the coils 8 and 9 for effective charging. One example of such features is that the device 21 could be provided with a male feature such as a projection or hook 22 (as shown in FIG. 1) and the device 24 could be provided with a female feature such as an indentation or hole 25. The male and female features could be reversed, and/or other forms of physically cooperating features could be provided. One example of another form of physical cooperation is that one of the devices could comprise two members connected by a hinging connection. That device could be hinged shut so as to fully or partially enclose some or all of the other device, thereby limiting relative motion of the two devices. Another form of physical cooperation is that one of the devices could have a magnet that can be attracted to a magnet or magnetic susceptor member of the other device. The locations of the magnet/susceptor of each device would be selected so as to allow the magnet(s) to hold the devices in a mutual position that is favourable for charging.

Second, the device 24 to be charged may be provided with means whereby its identity or other information indicative of its characteristics for charging may be read by the charging device 21. Examples of such means include a radio frequency (RF) tag, circuitry for modulation of the charging field which could be picked up by a detector attached to the primary coil, and a transmitter for transmitting optical (e.g. infra-red signals). The charging device would be provided with an appropriate reader. FIG. 2 illustrates the example of an RF tag 2 which can be read by a corresponding RF tag reader 1 in the charging device 21. The RF tag can transmit information that enables the charging device to charge the device 24 more efficiently. Such information could, for example, be an indication of preferred charging voltages and/or currents and their preferred variation over time, or other charging algorithm characteristics. Such information could be provided to the RF tag 2 from a central processing unit (CPU) 4 of the device 24 in response to the state of charge of the battery. The information is received by the reader 1 and passed to a CPU 3 of the charging device 21 which varies the operation of the charging components—particularly the DC-AC converter 7 to achieve those desired characteristics. Alternatively the device 24 could transmit an identity by means of which the device 21 could find its preferred charging characteristics from a look-up table stored by the device 21.

Where the device 24 to be charged has means capable of transmitting information for use in enhancing its charging, that means may be activated by interaction with the charging device. For example, the device to be charged may have a switch that is pressed when the devices are moved into mutual engagement, or that is activated by the proximity of a magnet (preferably as described above) of the charging device. Alternatively, the transmitter means could be activated when the device 24 detects that it is being inductively charged.

The charging device 21 could have a memory that is configurable by a user to store a list of identities of devices that the charging device is permitted to charge. The CPU 3 of the charging device could then provide charging only to devices that report those identities. This allows the user to limit the devices with which his charger can be used.

The battery of the charged device could be charged by other means, for example by another type of inductive charger or by an electrical connection to the device.

The charging device 21 could itself provide a user with functions other than charging, using its energy source 5. The charging device could, for example be a mobile phone, a PDA or a torch.

The purpose of the capacitors 6, 11 is to buffer the charging field and allow faster charging when the battery of the device 24 is very low. This allows the device 24 to be used more quickly when its battery has been depleted to a very low level. The capacitors 6, 11 could be omitted.

The energy source 5 of the charging device 21 stores energy locally in or on the device 21. The device 21 can thereby provide charging energy to the device 24 without the need for simultaneously receiving energy from another source such as the electrical mains. This means that the charging device 21 can be taken out and about by a user and used wherever he needs to revitalise his electrical devices. For this purpose the device 21 is preferably sized and configured so as to be portable. The energy source 5 is preferably capable of storing energy suitable for charging for a prolonged period, preferably more than a week, and more preferably more than a month.

The devices 21 and 24 could be any electrically operated portable devices. Non-limiting examples include mobile phones, PDAs, laptop computers, torches, personal music players, watches and televisions. The device 21 could be a dedicated charging device.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A kit comprising an inductive charger having a first coil and a portable device having an energy store and a second coil coupled to the energy store whereby the energy store can be charged from a varying electrical field applied across the first coil, the charger and the device being configured remotely from the coils for encouraging coupling between the first and second coils when the charger and the device are located against each other.

2. A kit as claimed in claim 1, wherein the charger comprises a DC to AC converter for forming the varying electrical field across the first coil and a capacitor connected between the DC to AC converter and an energy store local to the charger by which the field is formed.

3. A kit as claimed in claim 1, wherein the charger comprises a receiver for receiving data indicative of one or more charging parameters and the charger is arranged to alter one or more characteristics of the varying electrical field in response to the received data.

4. A kit as claimed in claim 3, wherein the receiver is a radio frequency receiver.

5. A kit as claimed in claim 3, wherein the receiver is an optical receiver.

6. A kit as claimed in claim 3, wherein the receiver is connected to the coil and is capable of detecting the data by means of the coil.

7. A kit as claimed in claim 3, wherein the device comprises a transmitter for transmitting data capable of identifying a charging strategy to the receiver.

8. A kit as claimed in claim 1, wherein the charger comprises a central processing unit and a user interface whereby a user of the device can interact with the central processing unit for the provision of a non-charging function by the device.

9. A kit as claimed in claim 1, wherein the device is a mobile phone.

10. A portable charging device as claimed in claim 1, wherein the energy store of the device is a battery.

11. A kit as claimed in claim 1, wherein the charger and the device are configured by means of mutually interlinking physical features remotely from the coils for encouraging coupling between the first and second coils when the charger and the device are located against each other.

12. A kit as claimed in claim 1, wherein the charger and the device are configured by means of mutually attracting magnetic features remotely from the coils for encouraging coupling between the first and second coils when the charger and the device are located against each other.

13. A kit comprising an inductive charger having a first coil and a portable device having an energy store and a second coil coupled to the energy store whereby the energy store can be charged from a varying electrical field applied across the first coil, the charger comprising a receiver for receiving data indicative of one or more charging parameters and the charger being arranged to alter one or more characteristics of the varying electrical field in response to the received data.

14. A kit as claimed in claim 13, wherein the charger comprises a DC to AC converter for forming the varying electrical field across the first coil and a capacitor connected between the DC to AC converter and an energy store local to the charger by which the field is formed.

15. A kit as claimed in claim 13, wherein the receiver is a radio frequency receiver.

16. A kit as claimed in claim 13, wherein the receiver is an optical receiver.

17. A kit as claimed in claim 14, wherein the receiver is connected to the coil and is capable of detecting the data by means of the coil.

18. A kit as claimed in claim 13, wherein the device comprises a transmitter for transmitting data capable of identifying a charging strategy to the receiver.

19. A kit as claimed in claim 13, wherein the charger comprises a central processing unit and a user interface whereby a user of the device can interact with the central processing unit for the provision of a non-charging function by the device.

20. A kit as claimed in claim 13, wherein the device is a mobile phone.

21. A kit as claimed in claim 13, wherein the energy store of the device is a battery.
